(19) United States
(12) Patent Application Publication
(10) Pub. No.: US 2015/0225986 A1
(43) Pub. Date: Aug. 13, 2015

(54) PADLOCK

(71) Applicant: KNOCK N'LOCK LTD., Yokneam (IL)

(72) Inventor: Ilan Goldman, Herzliya (IL)

(21) Appl. No.: 14/427,808

(22) PCT Filed: Aug. 21, 2013
(86) PCT No.: PCT/IL2013/050710

§ 371 Date: Mar. 12, 2015

Related U.S. Application Data
(60) Provisional application No. 61/700,403, filed on Sep. 13, 2012.

(51) Int. Cl. E05B 67/02

(52) U.S. Cl. CPC E05B 67/02

(57) ABSTRACT

The invention concerns padlocks having an outer face with a three-dimensional surface pattern on a portion of the outer face, the pattern being effective to increase surface resistance towards drilling. The invention further concerns padlocks with sealing arrangements and blocking elements axially displaceable between non-blocking and blocking positions.

### TECHNOLOGICAL FIELD

This invention relates to padlocks.

### BACKGROUND

Padlocks, typically electronically-operated, are disclosed in WO 90/15910, WO 98/39538, WO 06/130660 and WO 06/136851. In such padlocks, unlocking is induced by an electrical system upon verification of an unlocking code received from a user.

### REFERENCES

References considered to be relevant as background to the presently disclosed subject matter are listed below:

WO 90/15910

WO 98/39538

WO 06/130660

WO 06/136851

WO 98/39539

WO 01/59238

Acknowledgement of the above references herein is not to be inferred as meaning that these are in any way relevant to the patentability of the presently disclosed subject matter.

### GENERAL DESCRIPTION

The invention concerns a padlock. As generally known, the padlock has a lock body with two elongated openings, which may be bores formed in the lock body. In the following the padlock's elements will be described with respect an up-down axis, the upper part being that having the upper end of the openings. Thus, an upward direction is one towards such an upper end and a downward being one in the opposite direction.

The padlock also includes a generally U-shaped shackle with two arms, each defining an axis, with the axes being parallel to one another. Each arm fits into one of the openings. For locking, the shackle's arms are inserted into the openings and pushed axially until a locking position is reached. When unlocked, the shackle is pulled axially in the opposite direction to release the shackle from the body.

Several aspects of a padlock are disclosed herein that may be combined and embodied in a single padlock, although each of these aspects may be independently employed and, thus, a padlock according to the invention may also embody one or less than all of these aspects.

By one aspect, the “patterned surface aspect” the lock body has a three-dimensional surface pattern on at least a portion of its outer face. The pattern is effective in increasing resistance to drilling thereby making it considerably more difficult to tamper with the lock. The increased drilling resistance results from a number of factors. For example, the lack of a flat surface may cause the drill head to slip and thereby prevent to initiate the drilling. Also, the rotation of the drill head may be arrested by the uneven or slanted surface surrounding the drilling site. Said surface portion may be undulated, corrugated or rough. It may also have a wavy cross-sectional shape with apexes and troughs linked by straight (and slanted) or curved surfaces. An example is a cross-section with a substantially sinusoidal cross-sectional shape. The distance between the apexes may, for example, be between about 3 mm and about 6 mm. As can be appreciated, the patterned surface may cover the whole or only part of the outer face. Typically, at least the broader faces of the padlock will be so patterned.

By another aspect, the “locking aspect”, the padlock includes a locking arrangement that comprises a shackle-engaging assembly, a locking element and a blocking element. The shackle-engaging assembly comprises one or two engaging elements configured to be received in a recess, formed at the end portion of at least one of the arms on the side of the arm facing the other. The engaging elements are displaceable in a radial direction between an engaging state, in which at least one of the engaging elements is received in said recess, and a non-engaging state (in which it moves out of the recess to permit axial displacement of the shackle) and being biased into the engaging state.

The locking element has a first state in which it locks the engaging element in the engaging state, and has a second state that permits displacement of the engaging element from the engaging to the non-engaging state (to thereby permit release of the shackle from the lock body). A blocking element is accommodated at the bottom end portion of the opening, and is axially displaced between a non-blocking position in which it is situated in the bottom end, and a blocking position in which it is situated radially opposite the engaging element to thereby block radial displacement of the engaging element into the engaging state. The blocking element is biased into the blocking position and is displaced into the non-blocking position upon insertion and displacement of the arms into the locked state.

An unlocking sequence of the padlock includes first a switch of the locking element from the first to the second state, in which it permits radial displacement of the engaging element into the non-engaging state. Pulling the shackle in a direction away from the body will urge the engaging element into the non-engaging state, during which the blocking element will move axially into the blocking position, to thereby block the urged return displacement of the engaging element into the engaging state.

Upon insertion of the shackle back into the body and as a result of the axial displacement of the arms within the cylindrical opening, the blocking element is pushed downwards and axially displaced into its non-blocking position. Once the recess comes to lie opposite the engaging element, this element is urged back into the engaging state. The switch back of the locking element into the first state then prevents the return axial displacement of the engaging element, and thereby locks the shackle in position.

In one embodiment of the locking aspect, the recesses are formed at the end portions of both arms and the locking arrangement comprises two engaging elements to engage therewith. The recess typically has curved walls, a fact that facilitates relatively smooth axial displacement of the shackle with concomitant urging of the axial displacement of the engaging elements into the non-engaging state.

In accordance with an embodiment of the locking aspect, the switch of the locking element between its first and second states is by rotation. By another embodiment of the locking aspect the switch of the locking element between its first and second states is by an electrical motor actuation, for example a rotational motor.

According to one embodiment of the locking aspect, an open-indicator switch is provided, and being actuated by an element of the shackle-engaging assembly upon displacement of the engaging elements into the disengaging state. Once actuated, such an open-indicator switch provides electronic indication of the open state of the lock. When the switch is released upon displacement of the engaging element into the engaged state, the motor actuates the locking element to change from the second to the first state, to thereby lock the engaging element in their engaging state.

By an embodiment of the locking aspect, the locking element switches from the first to the second state upon an external actuation signal. An example of such actuation signal is a knocking code using, e.g. a knock code key of the kind disclosed in WO 98/39539 or any other device that is capable of transmitting a coded knocking code received by an acoustic receiver device, such as an accelerometer of the kind disclosed in WO 01/59238 (the contents of both these publications are incorporated herein by reference). The padlock also includes a processor for decoding the code and introducing an actuation signal to actuate the motor upon the verification of the code. This processor may thus also be linked to a switch of the kind described above. The processor may also include other functions, for example, the ability to change the code, time-based algorithms to define different codes for different times, etc.

By another aspect of the invention, the “open state sealing aspect”, the lock is provides with a sealing element at the bottom of the opening that is axially upwardly biased, whereupon unlocking the lock and removal of the shackle, the sealing element moves upwards toward the opening sealing the space below it. This protects internal elements, mechanical or electric/electronic, from water, e.g. when unlocking the lock in a rainy day. The sealing element typically comprises an O-ring that presses against the opening's internal walls. The O-ring by one embodiment is radially oriented and seated on top of a shoulder of the sealing element and seated between it and a pressing disc that can axially displace downwards relative to the sealing member against the O-ring (the O-ring compression elasticity is the biasing force opposing such displacement). When pressed downward, the disc compresses the O-ring causing it to press against the walls of the opening to thereby form a liquid-tight seal. The opening typically comprises a projection projecting into the opening's lumen that is configured for engagement with the pressing disc. Thus, the sealing element is upwardly displaced up to the point of such engagement, where the upward bias of the sealing element induces a relative slight upward movement thereof while the pressing disc remain stationary (or, seeing it in the other way, the pressing disc can be seen as being displaced downwardly relative to the sealing element) thereby compressing on the O-ring and causing it to bear tightly against the opening's internal wall to yield a fluid-tight seal. This sealing element may also be constituted by the blocking element then serving the dual role of a blocking element and a sealing element.

By another aspect, the “sealing aspect”, the padlock comprises a sealing arrangement in each of the openings. By one embodiment, the sealing arrangement comprises a flexible annular sealing element fitted within the opening's interior, about the axis, and having relaxed and strained states. In the relaxed state, the sealing element defines an opening with a diameter that permits the passage therethrough of an end portion of the arm. The full insertion of the shackle causes the sealing element to switch into the strained state, in which it bears tightly onto a portion of said end portion to thereby form a liquid-tight seal. Typically the sealing element defines an opening having a first diameter in its relaxed state and a second, narrower diameter than the first, in its strained state. The first diameter is designed to be larger than that of the end portion, thereby permitting its passage therethrough; and the second diameter is narrower than said portion and to this feature said element fits tightly about said portion.

The sealing element of said one embodiment may be an annulus having in its relaxed state a first, relaxed cross-sectional shape, with a first radial dimension and a first axial dimension; and in transitioning to its strained state being compressed in an axial direction to assume a second strained cross-sectional shape. The strained cross-sectional shape has a second axial dimension that is shorter than said first axial dimension, and a second radial dimension that is longer than said first radial dimension. In accordance with an embodiment of the dynamic sealing arrangement, the padlock has an urging member configured for urging the sealing element into the relaxed state. Such an urging member may, for example, be an elastic element disposed within an annulus of the kind defined above. Transitioning of the sealing element from a relaxed to a strained state may be achieved by a displaceable member disposed within the opening that is axially displaceable between two extreme states: a first state, in which it does not bear on the sealing element, e.g. it is spaced-apart therefrom; and a second state in which it bears onto said sealing element to cause it to transform into the strained state. Typically, the displaceable member is displaced through insertion and axial movement of the end portion of the shackle. The displaceable member may be constituted, for example, by a ring having an annular groove at its outer surface, defined between first and second shoulders, and accommodating an annular projection of a narrower diameter. The projection limits the displacement of the displaceable member between its first state in which the first shoulder bears against the projection and the second state in which the second shoulder comes to bear against the projection.

The displacement of the displaceable member from the first to the second state may be against the biasing force of a biasing arrangement that biases this member into the first state. The biasing arrangement may include one or both of (i) the intrinsic bias of the sealing element to revert back into its relaxed state, and (ii) by an auxiliary biasing arrangement associated with the displaceable member.

The sealing element according to said one embodiment may have a generally U-shaped cross-section with its open side bearing against walls of the opening. The closed end is directed towards the opening's interior and in the strained state bears tightly against said portion of the arm's end portion.

According to another embodiment the sealing arrangement comprises a generally annular sealing member situated around the opening and comprising at least one O-ring, fitted into an annular groove in its inner surface facing the bore's interior such that when the arms of the shackle are locked in position in the bore, the O-ring presses against the outer surface of the arm.

The shackle arms may be fitted with a shoulder separating between a narrower end portion and adjacent portions of the arms to permit relatively friction-free insertion of the arms into the bores during insertion into the bores during at least most of the way. In the cased of said one embodiment, such a shoulder may also serve to displace the displaceable member into its second state.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 is a side elevational view of a padlock in accordance with an embodiment in an unlocked state, the shackle being separated from the lock body.

FIG. 2A is a perspective view of the padlock of FIG. 1 in a locked state.

FIG. 2B is a schematic cross-section through the outer face of the body of a lock according to another embodiment.

FIGS. 3A and 3B are longitudinal cross-sections of the padlock of FIGS. 1 and 2 along the line III-III in the locked and unlocked states, respectively.

FIGS. 4A and 4B are cross-sections along the line Iv-Iv in FIG. 1 in respective first state and second state of the locking element.

FIG. 4C is the same cross-section as in FIGS. 4A and 4B with the two engaging elements being in the non-engaged state.

FIGS. 5A and 5B are cross-sections along the line V-V in FIG. 1 in the same states as in FIGS. 4A and 4B, respectively.

FIG. 5C is the same cross-section as in FIGS. 5A and 5B with the two engaging elements being in the non-engaged state as in FIG. 4C.

FIGS. 6A and 6B are longitudinal cross-sections through a padlock of another embodiment, in the respective, open and closed states.

FIG. 6C is an enlargement of the section marked 6C in FIG. 6A.

FIG. 7A is a partial cross-section along lines VII-VII in FIG. 6A.

FIG. 7B is a cross-section through line VII-VII in FIG. 6B.

### DETAILED DESCRIPTION OF EMBODIMENTS

In the following, specific embodiments are described with reference to the annexed drawings. A person versed in the art will appreciate that these embodiments are but an example of a myriad of embodiments that are made possible by the invention and fall within the scope of the invention as described above in the general description or in the appended claims. Thus, by way of example only, there may be different urging mechanisms than those described for engaging elements 182 and blocking member 220; groove 162 may or may not be included; element 300 may not be included in some embodiments; the micro-switches 200 and 202 may or may not be included or the electronic mechanism may be different to that described; the displaceable member that deforms the sealing element into its strained state may be different; the sealing element itself may be different; etc.

Consistent with the general description, the term “axial” or “axially” is described with reference to longitudinal axes of the shackle's two arms. Accordingly, the term “radial” or “radially” is defined as the direction normal thereto.

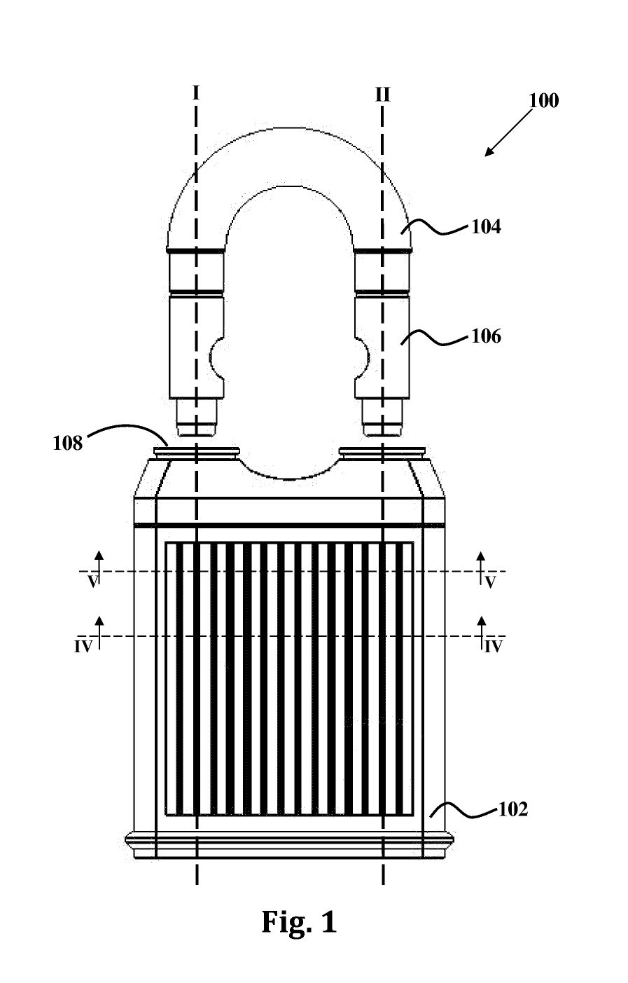

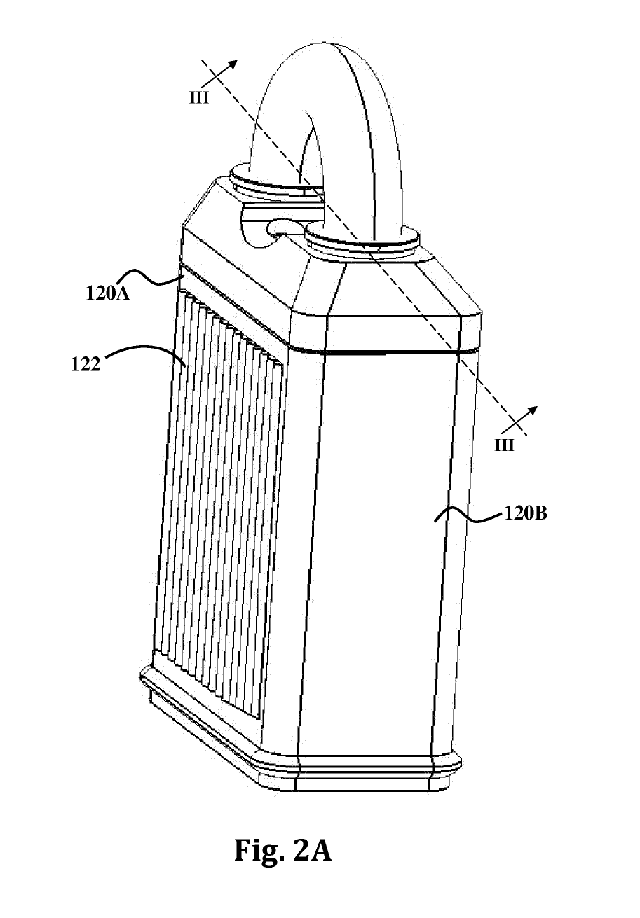

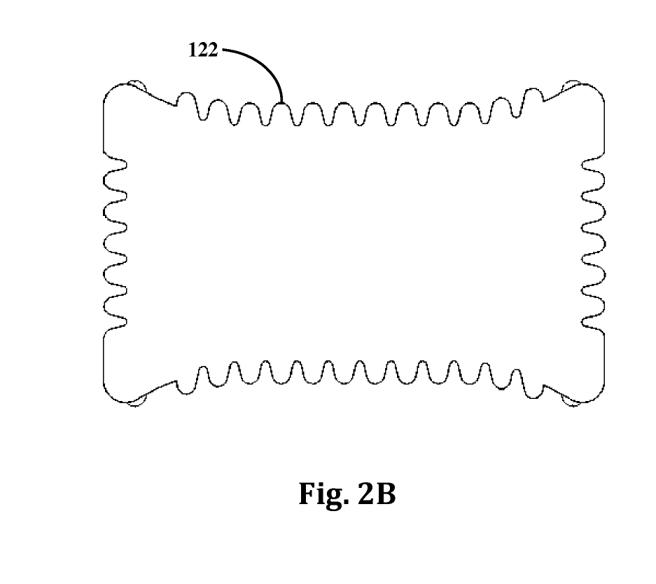

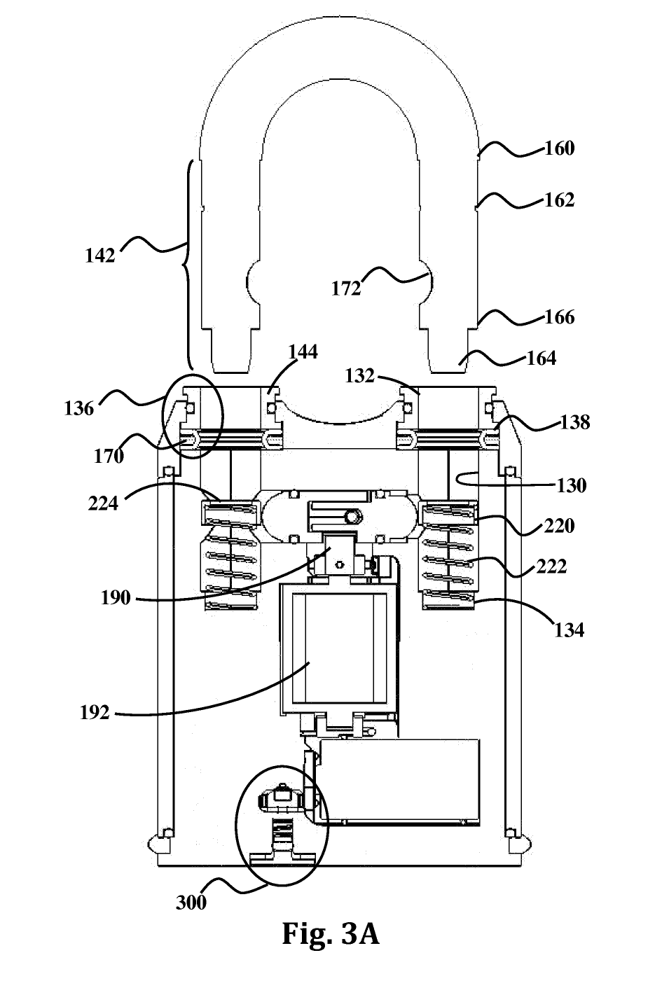

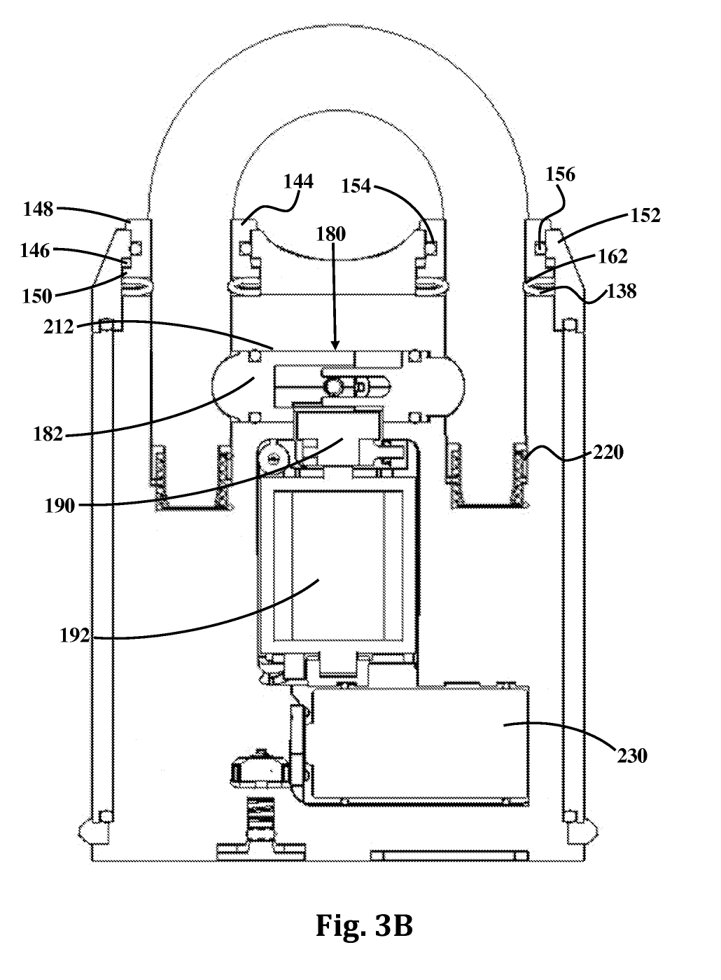

Furthermore, the lock is described with reference to a “locked state” shown, for example, in FIGS. 2 and 3B; and the “unlocked state” in which the shackle is disengaged from the lock body as shown, for example, in FIGS. 1 and 3A.

Also consistent with conventional definitions, the micro-switches are described with reference to an “open state” in which they do not close an electric circuit and in “closed state” in which they do close an electric circuit.

Reference is first made to FIGS. 1 and 2A showing the lock, generally designated 100, that comprises a lock body 102 and a substantially U-shaped shackle 104 with two arms 106 extending axially along parallel axes I and II, each fitting into opening 108. Openings 108, as will be shown below, are elongated cylindrical bores formed in the lock's body. For switching between the unlocked state of the padlock, shown in FIG. 1, and locked state shown in FIG. 2A, the shackle and/or the lock body are axially displaced one towards the other. When unlocking, the two arms are pulled away from one another.

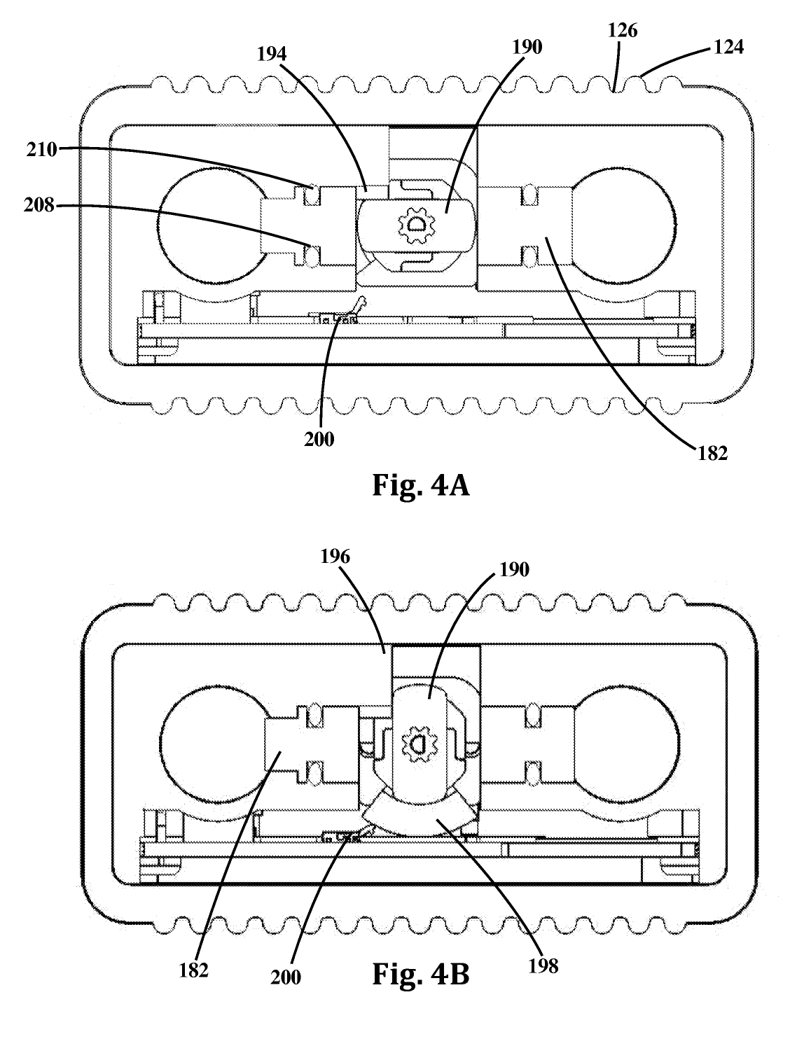

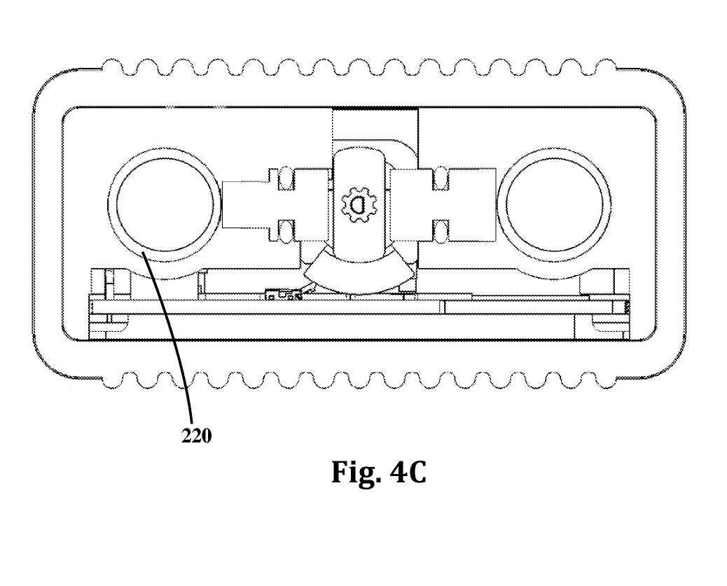

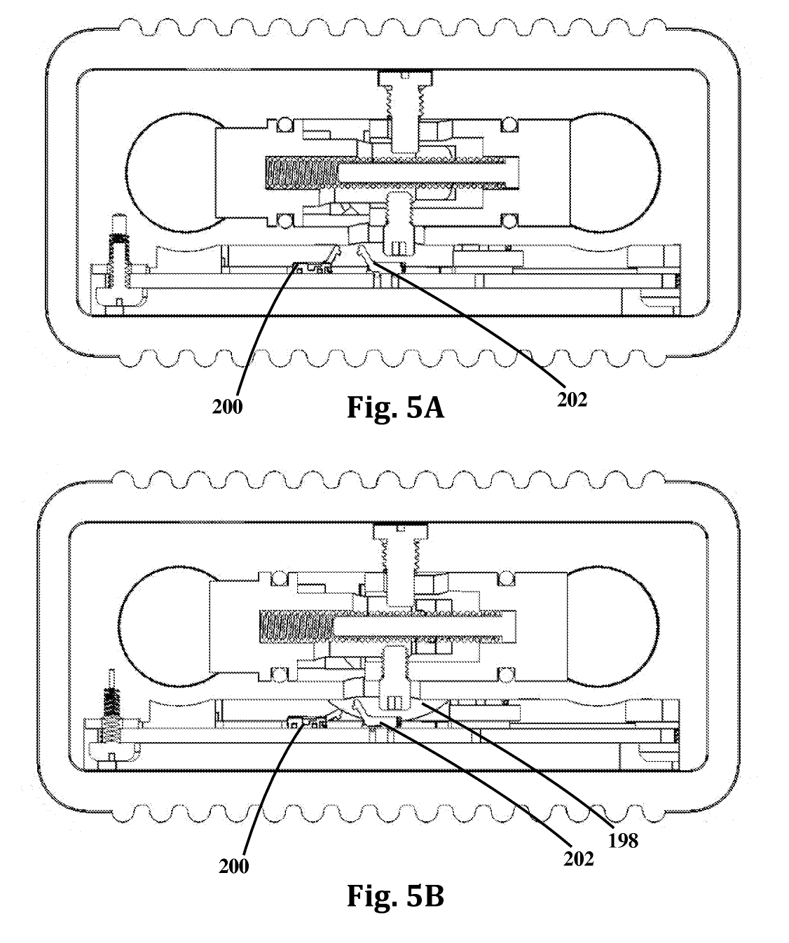

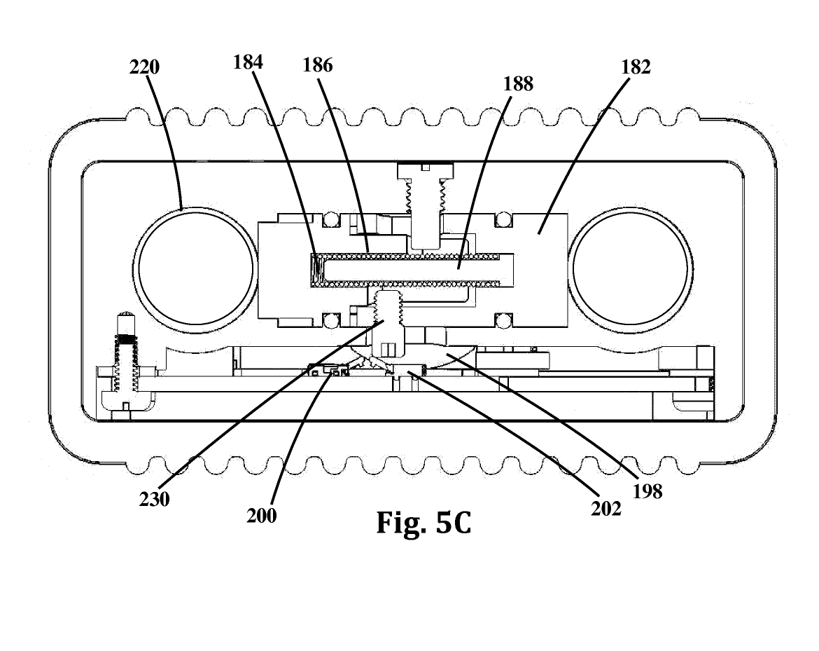

The lock body has an outer face 120, typically made of metal, such as steel alloy, which is hardened or case-hardened (surface hardening). The outer face 120 consists of broad sides 120A and narrow sides 120B, with a 3-dimensional (3D) pattern 122 formed on the broad sides 120A which, as can be seen in FIGS. 4 and 5, has an overall periodical undulated or wavy cross section (sinusoidal-like) with ridges 124 and troughs 126 linked to one another by curved surfaces. As can be appreciated, the surface pattern may be other than one with a sinusoidal cross-section. For example, it may be a generally rough surface with an array of projections and low points between them that are linked by curved or slanted surfaces; such projections may be randomly distributed; the apexes of the projections may be uneven; etc. Also, in the case of an undulated or wavy surface pattern, the undulations/waves may not necessarily be periodical. Furthermore, while as shown herein said 3D pattern is formed only on the broad sides 120A, by some embodiments it may also be extended to the two narrow sides 120B. As can be appreciated by a person skilled in the art, this surface pattern has the effect of increasing resistance of the surface to drilling. This is caused, among others, by rendering it difficult for the drilling head to initiate a drilled hole. Also, when attempting to drill, the drill head will slip towards the trough and the friction between the curved walls and the sides of the drill head may block rotation, and break the drill head.

A cross-section of the outer surface of a body of a lock of another embodiment is seen in FIG. 2B. Whereas, in the embodiment of FIGS. 1 and 2A the periodical undulated or wavy (sinusoidal-like) cross section appear on two opposite faces, in the embodiment of FIG. 2B it is on all four faces. Also, the ratio between the amplitude (namely the span between the peak of the ridges and the troughs between them) and the period (namely the distance between peaks or troughs) is larger in the latter embodiment as compared to the former, as can be seen in particular when comparing FIG. 2B with FIG. 4A or FIG. 4B. Furthermore, in the embodiment of FIG. 2B the broad side is inwardly curved, which is another element that hampers drilling through the outer surface.

Reference is now made to FIGS. 3A and 3B. As can be seen, openings 108 extend into axial bores 130, each of which having an external end 132 and an internal end 134. A sealing arrangement 136 is formed proximal to end 132 and it comprises a flexible annular sealing element 138, having a relaxed state seen in FIG. 3A and a strained state seen in FIG. 3B.

As can be seen in FIG. 3A, in the relaxed state, sealing element 138 defines an opening having a diameter sufficient to permit unhindered passage therethrough of an end portion 142 of the shackle's arm. In the manner to be explained further below, upon insertion of the shackle (the state shown in FIG. 3B), sealing element 138 switches into the strained state, in which it is pressed to become more flattened; thus, the sealing element 138 deforms form its relaxed state, in which it has a cross-sectional shape with a first radial dimension and a first axial dimension, to a strained state in which it is compressed in an axial direction, to assume a second, strained cross-sectional shape, with a second axial dimension shorter than the first axial dimension and a second radial dimension being longer than the first radial dimension. In its strained stated, sealing element 138 bears tightly onto end portion 142.

Sealing arrangement 136 also includes a displaceable member 144 which is a ring-like element that has an annular groove 146 which is defined between first and second shoulders 148 and 150. This annular groove 146 accommodates an annular projection 152, which has a narrower diameter than groove 146. Thereby the displaceable member 144 can be axially displaced, the extent of the displacement being defined through the difference between the diameter of groove 146 and projection 152.

Accommodated within a channel 154 formed in groove 146 is an O-ring 156 that provides for a fluid-tight seal between member 144 and projection 152.

In its first state, seen in FIG. 3A, the displaceable member 144 is at its most outwardly position, in which shoulder 150 bears against projection 152. In this state, sealing element 138 is in its relaxed state, defines an internal diameter which is sufficient to permit the unhindered passage of end portion 142 of shackle 104; namely, a diameter that is the same or slightly larger than the broader portion of end portion 142.

End portion 142 terminates with shoulder 160. Upon insertion of the shackle into the bores, shoulder 160 engages and bears on the outer face of displaceable member 144 and consequently, in the final step of this axial displacement it causes displacement of the displaceable member 144 into its second state, shown in FIG. 3B, in which it bears onto sealing element 138 causing it to switch into its strained state as noted above.

Defined on the face of end portion 142, at a distance from shoulder 160, is an annular groove 162, which, in the locked state (shown in FIG. 3B) receives the tip of sealing element 138 to improve the fluid-tight seal between the sealing element 138 and end portion 142 of arm 106. Such an arrangement results in a fluid-tight seal that may be effective to isolate the internal mechanism of the lock from the outside environment even upon immersion of the lock into water, e.g. up to a depth of 1 meter.

Upon unlocking (through a mechanism to be described below), displaceable member 144 will be displaced to its first state by the urging force provided by the sealing element 138 owing to its intrinsic bias to revert to its non-strained state. In some embodiments, an auxiliary urging member may be disposed within lumen 170 of element 138, to provide an auxiliary urging force, or an auxiliary urging member may be included, for example when disposed in the clearance between shoulder 148 and projecting 152.

A locking arrangement according to an embodiment of the invention will be described now with reference to FIGS. 3A-5C. End portion 142 of each arm 106 includes a recess 172 on the face of each of the arms that faces the other. The locking arrangement includes a shackle-engaging assembly 180 that comprises two engaging elements 182 with ends that are configured to be received in the recesses. The engaging elements 182 are displaceable in a radial direction between an engaging state (that can be seen, in particular, in FIGS. 3B, 4A and 5A), in which the outer face of engaging element 182 is received within recess 172, and a non-engaging state (that can be seen, in particular, in FIGS. 3A, 4C and 5C). The urging force of spring 184, accommodated within recess 186 in one of the elements and over rod 188 in the other element, biases the engaging elements into the engaging state. As can be appreciated, spring 184 and the manner it biases said elements into the engaging state is but one example of such a bias.

The locking arrangement also includes a locking element 190 that has a first state seen in FIGS. 3B and 4A, in which it locks the engaging elements 182 in the engaging state (and blocks them from radial displacement into the non-engaging state); and has a second state, seen in FIGS. 3A and 4B, in which it permits such displacement of the engaging elements into the non-engaging state. The shift between the two states is through right-angled axial rotation by means of motor 192. As can be seen in FIGS. 4A and 4B, the axial rotation of locking member 190 is within a space defined inside the lock body and is limited in its first state by a wall portion 194 of that space, and in its second state by another wall portion 196.

Locking element 190 is in rotational association with a crescent-shaped element 198. Locking element 190 and crescent-shaped element 198 are weight-balanced about the rotating axis (namely, the weight distribution is such that the net inertia upon rotational movement about the axis will be zero) thereby preventing unwanted rotation during occasional vibrations or burglary attempts by impact or vibrations. The crescent-shaped element 198 engages micro-switch 200, as will also be explained below. Thus, upon rotation of locking element 190, element 198 rotates therewith. Each of elements 182 also has annular groove 208, which incorporates an O-ring 210 providing for a fluid-tight seal between the walls of the axial bore 212, in which they are accommodated. Thus, for example, in case some liquid enters into bore 130, when the shackle is disengaged from the lock body in the unlocked state of the lock or upon failure of the seal imparted by sealing element 138 in the locked state, the O-ring 210 provides for extra protection against ingress of liquid into the lock mechanism.

The locking arrangement also includes a blocking element 220 that is accommodated within the cylindrical bore and is axially displaceable between a non-blocking position, seen in FIG. 3B, in which it is situated at the bottom end of an opening and a blocking position, seen in FIG. 3A, in which it is situated radially opposite the engaging element. The blocking element 220 is biased into the blocking position by a spring 222. Thus, upon release of the shackle 104 into the unlocked state, displaceable member 220 is biased into its blocking position, seen in FIG. 3A.

Displaceable member 220 has an opening 224 with a diameter permitting passage therethrough of the end segment 164 of arm 106 that extends up to shoulders 166. Shoulder 166 has a diameter wider than opening 224. Thus, upon axial insertion of arms 106 of the shackle into bores 130, shoulders 166 engage and bear on displaceable member 220 to displace it into the non-blocking position, shown in FIG. 3B, against the biasing force of spring 222.

The locking arrangement also includes two micro-switches 200 and 202, the functions of which will be explained below. Further included in the lock are battery 230 and other electronic components (not shown) including, inter alia, a receiver for receiving of an lock-opening signal, which may by an antenna for receiving an electromagnetic signal, a photovoltaic cell for receiving a light signal (in the visible, IR, or UV spectrum), an acoustic receiver for a receiving a sound-encoded signal (such as that disclosed in WO 01/59238 (the content of which is incorporated herein by reference), a processor, etc.

The sequence of operation between a locked state and unlocked state and vice-versa will now be described. In a locked position, shown in FIGS. 3B, 4A and 5A, arms 106 of the shackle are fully inserted into bores 130. In this position, the engaging elements 182 are fully received in recesses 172 and locked into this position by the locking element 190. Thus, the shackle is firmly locked in its locked position. Furthermore, in this position, the blocking element 220 is in the non-blocking position, shown in FIG. 3B.

Upon receipt of an unlocking signal which may typically be a knocking code signal, using a mechanism of the kind disclosed in WO 98/39539 that is picked up by an acoustic receiver such as an accelerometer disclosed in WO 01/59238 (the contents of both these patent publications being incorporated herein by reference), a processor (not shown) that receives and decodes signals induces an opening signal to thereby cause the motor 192 to rotate locking element 190 from the first locked state, shown in FIG. 4A, to its second unlocked state, shown in FIG. 4B. The arrangement is such that a window of defined period of time is provided for removing the shackle. If during such period of time the shackle is not removed, the locking element is rotated back to its first, locking state, shown in FIG. 4A.

In order to conserve battery, the lock includes an external switching assembly 300 that turns on the electric/electronic mechanism of the padlock. In other words, the electric/electronic mechanism is off until being turned on by this actuation mechanism. Typically, a defined window of time is provided for a user to provide the proper opening signal. Then again, there is a defined period of time in which the lock will remain open, as noted above.

Once locking element 190 is in its second state, engaging elements are free to displace in a radial direction into the non-engaging state. Upon pulling of the shackle, the engaging elements 182 will become radially displaced into a non-engaging state. During pulling of the shackle 104 in a direction away from the lock body, the blocking member 220 is axially displaced along with arms 106 up to a blocking position, seen in FIG. 3A, in which it lies radially opposite the engaging elements maintaining them in the non-engaging state. While in this state, arms 106 of shackle 104 can be reinserted at any time in order to lock the padlock.

As noted above, the locking arrangement comprises two micro-switches 200 and 202, the function of which will now be explained. First, micro-switch 200, as can best be seen in FIGS. 4A and 4B, is open in the locked state of the padlock. Upon initiation of the unlocking sequence by rotation of element 190, element 198 presses micro-switch 200 into a closed state, whereby it provides an indicator of the open state of the locking element 190. If the subsequent unlocking sequence is not continued within a defined time window, the processor sends a signal to element 190 to thereby turn it back into its locking state, as already noted above. The switch 202 is an open-indicator switch that is pressed by pin 230, once engaging elements 182 are displaced into the non-engaging state. This provides another signal indicating that the lock is in its unlocked state.

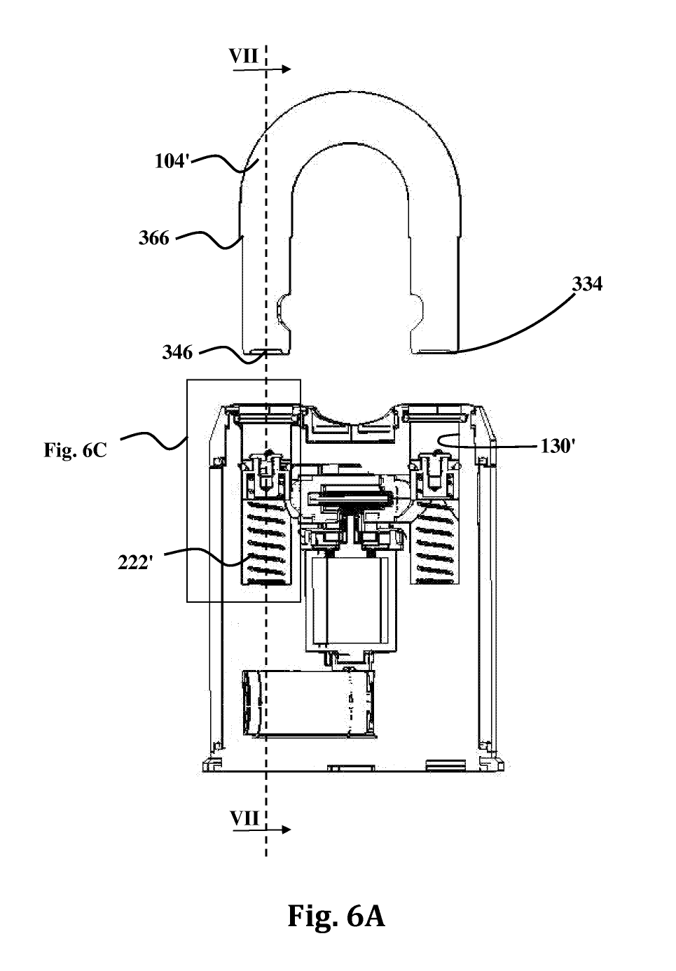

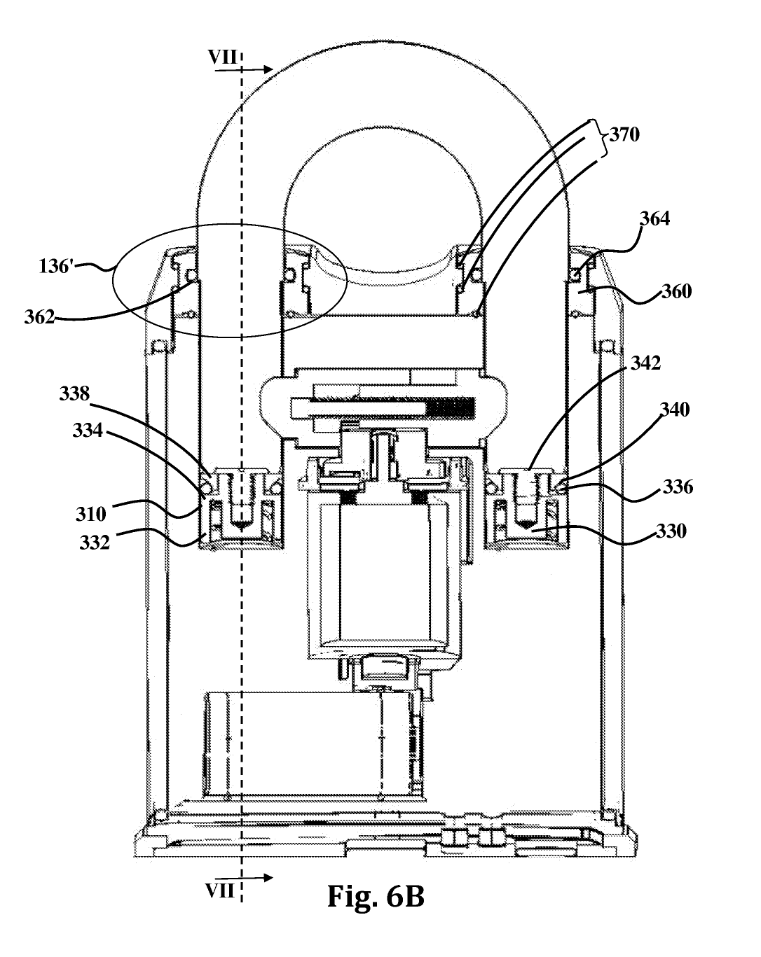

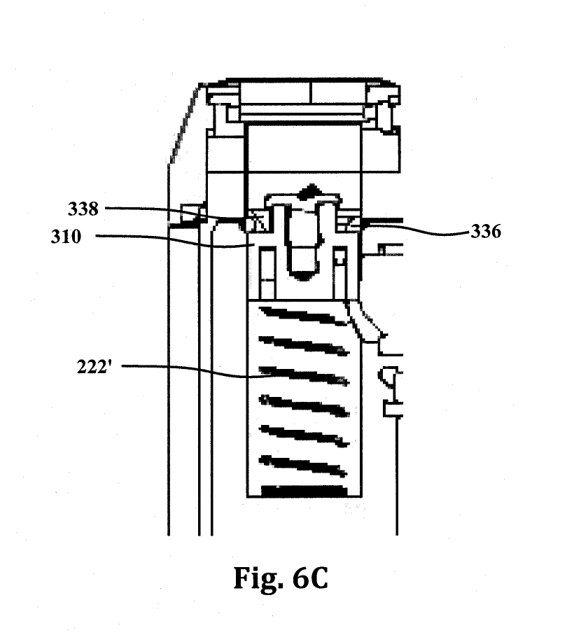

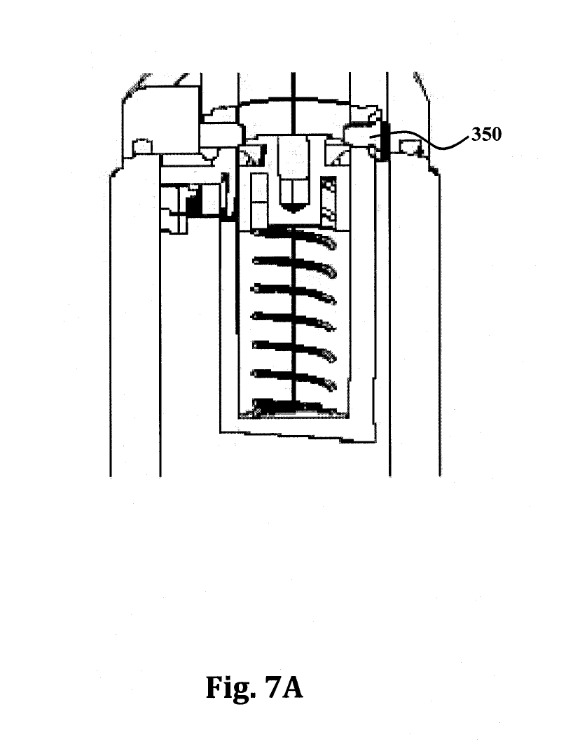

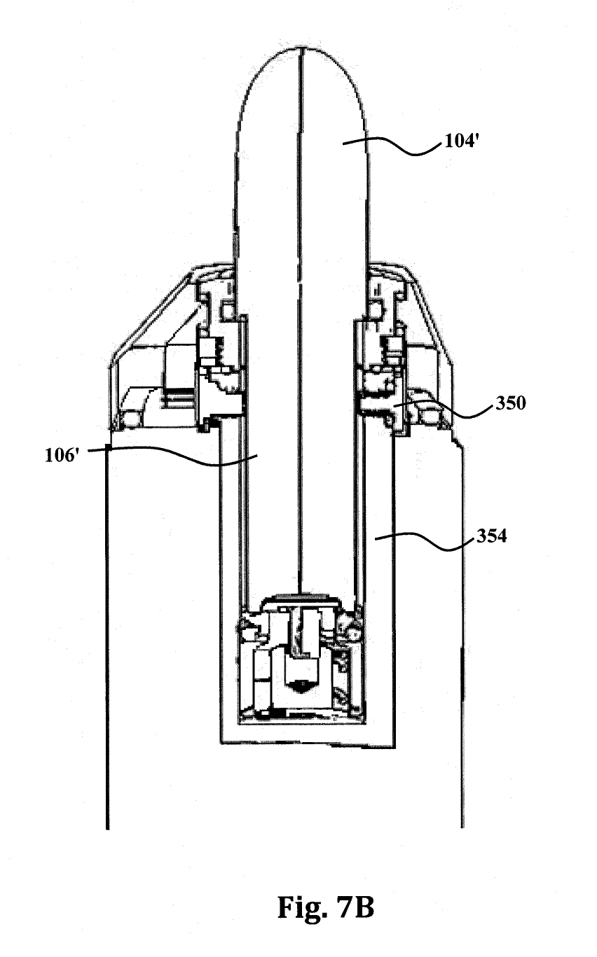

Another embodiment of the invention is shown in FIGS. 6A-7B. Many of the elements in a padlock of this embodiment are similar in structure and function to the padlock shown in FIGS. 3A and 3B; and these elements have been given like reference numerals with a prime indicator. The reader is referred to the description above for their structure and function.

One difference in this latter embodiment to that described above, concerns an arrangement intended for sealing internal elements in the open state. As can be seen, particularly in FIGS. 4A-4B, the locking element is fitted with O-ring 210 intended to seal internal components (including elements 192, 230, and others) from water that may accidentally enter the bores in the open state, e.g. on a rainy day.

In the embodiment shown in FIGS. 6A-7B, an alternative sealing arrangement is provided. In this embodiment, element 310 plays a dual role as blocking element, similar to element 220 of the other embodiment, and as a sealing element. As can be seen in FIG. 6B, element 310 is associated with a helical biasing spring 222′ that biases element 310 upward. In the locked state, shown in FIG. 3B, helical spring 222′ is accommodated in the space formed between central portion 330 and external skirt 332. Element 310 has a shoulder 334 that supports an O-ring 336, fitted between shoulder 334 and pressing disc 338. Pressing disc 338 has an upwardly slanted surface 340 engaging O-ring 336. As can be seen, there is clearance between the bottom end of disc 338 and shoulder 334, and consequently it can move downward relative to element 310. In such relative downward movement, the slanted surface 340 presses O-ring 334 outward towards the walls of axial bore 130′. Disc 338 is held in position by the head of screw 342.

As can be seen in FIGS. 6A and 6B, the bottom face 344 of shackle 104′ has a recess 346 that matches the head of screw 342. Thus, in the locked state, seen in FIG. 6B, disc 338 is in its most upward position with respect to element 310.

Upon opening the lock and removal of the shackle, the biasing force of spring 222′ causes the upward displacement of element 310 to its fully upward position, as seen in FIG. 6A. In this position, skirt 332 provides the blocking function, similarly to that of locking element 220, as seen in FIG. 3A.

As can be seen, particularly in FIGS. 7A-7B, projecting into the bore are radial projections 350 and in the fully upward position, upward bias of element 310 causes a relative movement between element 310 and pressing disc 338, thereby compressing O-ring 336 against walls of bore 130′.

As can be seen in FIG. 7B, the end sections of arms 106′ of shackle 104′ has elongated recesses 354, such that when inserted, projections 350 constituted by end of screw 352, will fit into it, thereby facilitating unhindered axial movement of arms 106′ within bore 130′.

The embodiments of FIGS. 6A-7B also differ from the one described above in that the sealing arrangement 136′ operates in a slightly different manner than sealing arrangement 136, shown in FIGS. 3A and 3B. In this embodiment, sealing arrangement 136′ includes a generally annular sealing member 360 that comprises an annular groove 362 at its inner face, accommodating an O-ring 364. In the fully locked state, shown in FIGS. 6B and 7B, O-ring 364 presses against outer walls of arms 106′ of shackle 104′. As can be seen in FIG. 6B, the end section of arms 106′ are somewhat narrower than the upper sections of the shackle and this change of diameter defines a shoulder 366. This ensures relatively friction-free downward movement of the arms of the shackle into the bore and the tight engagement between the O-rings and outer arms of the wall occur only in the locked position. This ensures minimum wear on the O-rings during use. It is to be noted that during manufacture of a shackle there may be a slight variation in the distance between the arms or in the diameter and this arrangement ensures lower sensitivity to such manufacturing tolerances.

As can also be seen in FIGS. 6B and 7B, the bottom portion with annular groove 362 of member 360 has a slightly narrower diameter than the upper portion. This diameter is enough to permit free passage of the narrow section of the arms 106′ but not the broader sections above it, and thus in the locked position shoulder 366 presses against opposite faces of groove 362.

As can also be seen in FIGS. 6A-7B, member 360 is provided with three additional O-rings, collectively numbered 370, affording an additional seal against moisture and the pressing of shoulder 366 on the bottom face of groove 362 compresses at least two of the O-rings to ensure a liquid-tight seal.

1. A padlock comprising
a lock body with an outer face and a substantially U-shaped shackle with two arms extending each in an axial direction and being axially displaceable between locked and unlocked states; the lock body having a three-dimensional surface pattern on a portion of the outer face, the pattern being effective to increase surface resistance towards drilling.

2. The padlock of claim 1, wherein the outer face is made of metal.

3. The padlock of claim 1, wherein said portion is corrugated or rough.

4. The padlock of claim 1, wherein said pattern has a rhythmic cross-sectional shape with apexes and troughs linked by curved surfaces.

5. The padlock of claim 4, wherein said pattern has a substantially sinusoidal cross-sectional shape.

6. The padlock of claim 4, wherein the distance between apexes is between about 3 mm and about 6 mm.

7. (canceled)

8. (canceled)

9. (canceled)

10. (canceled)

11. The padlock of claim 4, wherein said outer face is made of metal.

12. The padlock of claim 5, wherein said outer face is made of metal.

13. The padlock of claim 6, wherein said outer face is made of metal.
